(19) United States
(12) Patent Application Publication
(10) Pub. No.: US 2003/0058779 A1
(43) Pub. Date: Mar. 27, 2003

(54) Spindle device of a disc player

(75) Inventors: Suk-il Oh, Gyeonggi-do (KR); Young-sun Seo, Gyeonggi-do (KR); Young-won Lee, Gyeonggi-do (KR); Ki-won Yoon, Gyeonggi-do (KR)

Correspondence Address: STAAS & HALSEY LLP, 700 11TH STREET, NW, SUITE 500, WASHINGTON, DC, 20001, US

(73) Assignee: Samsung Electronics Co., Ltd., Suwon-city (KR)

(21) Appl. No.: 10/166,395

(22) Filed: Jun. 11, 2002

(30) Foreign Application Priority Data
Sep. 27, 2001 (KR) 2001-60136

(51) Int. Cl. G11B 23/00; G11B 25/00

(52) U.S. Cl. 369/263; 369/264

(57) ABSTRACT

A spindle device of a disc drive, including a self-compensating dynamic balancer. The spindle device includes a turntable on which a disc is to be placed, a spindle motor to rotate the turntable, a moving body to compensate for the eccentric center of gravity due to the asymmetry of the disc, and a self-compensating dynamic balancer having a race in which a moving body moves. The self-compensating dynamic balancer includes an annular race encircling the rotational center of the turntable and having a predetermined depth and width, and an annular moving body placed in the race, the annular moving body has an inner diameter wider than that of the race and an outer diameter narrower than that of the race, so that the eccentric center of gravity thereof can be moved in the race.

### CROSS-REFERENCE TO RELATED APPLICATIONS

This application claims the benefit of Korean Application No. 01-60136, filed Sep. 27, 2001, in the Korean Industrial Property Office, the disclosure of which is incorporated herein by reference.

### BACKGROUND OF THE INVENTION

1. Field of the Invention

The present invention relates to a spindle device of a disc player, and more particularly, to a spindle device of a disc player including a self-compensating dynamic balancer capable of suppressing internal vibration due to the eccentric mass of a disc.

2. Description of the Related Art

In general, a disc player is an apparatus to record and reproduce information onto and from a recording medium, such as a compact disc (CD), a CD-ROM, a digital versatile disc (DVD), and a DVD-ROM. Due to the sensitivity of the reading and/or recording process with respect to vibration, the disc player must protect a disc or an optical pickup from external impacts and internal vibration.

Internal vibration is mainly due to the eccentric mass of a disc when a spindle motor rotates. Much research has been done on the development of a disc player capable of dampening the internal vibration. Here, the eccentric mass of a disc is caused by a discrepancy between the center of rotation and the center of gravity of a rotating body due to an error during the manufacturing process of the disc. The eccentric mass of a disc results in the revolution of a rotational shaft of the spindle motor, i.e., rotations. The rotation of the rotational shaft of the spindle motor hardly affects the performance of a disc player at a lower playback speed, such as one-time (1×) or two-time (2×) playback speed, but clearly affects the recording and reproduction of a disc player at a high playback speed, e.g., 6× or 8× playback speed. To solve this problem, in conventional high-speed disc players, the mass of a deck plate to which a spindle motor is attached or the hardness of buffering members is increased to reduce the movement of the deck plate due to the eccentric center of gravity of the disc. However, although the mass of the deck plate is increased, the motion of the deck plate does not sufficiently decrease when the disc revolves at a high speed, and further the size and manufacturing costs of a disc player increase. Additionally, if the hardness of the buffering members is increased, it is difficult to effectively block vibration or shocks from the outside.

FIG. 1 is a schematic view of an example of a conventional spindle device capable of solving these problems, and FIG. 2 is an exploded perspective view of a turntable 6 attached to the spindle device of FIG. 1. In the spindle device of FIG. 1 and the turntable of FIG. 2, a self-compensating dynamic balancer is used to suppress the eccentricity of a disc using the relationship between the center of rotation and eccentric mass of a disc.

Referring to FIGS. 1 and 2, a rotational shaft 7a of a spindle motor 7 is coupled to a turntable 6 on which a disc 3 is to be placed. A cylindrical unit 6d through which the rotational shaft 7a passes is installed at the center of the turntable 6 and united with a self-compensating dynamic balancer along the edges of the turntable 6.

The self-compensating dynamic balancer includes a ring-shaped race 6a around the peripheral portion of the turntable 6 and having a predetermined width and depth, oil 6b which is contained in the ring-shaped race 6a to a desired depth, a plurality of moving members 5 that are inertial mass units submerged in the oil 6b in the race 6a, and a lid 6c to cover the top of the race 6a. The moving members 5 may have various shapes, e.g., spherical or cylindrical. Reference numeral 4 of FIG. 1 denotes a buffering member that prevents the gliding of the disc 3 and absorbs outer shocks to a certain degree.

A clamp 1 to fix the disc 3 to the turntable 6 is positioned at the top of the turntable 6. A spherical permanent magnet 2 is placed at a spherical concave 6e adjacent to the center of the turntable 6, and a magnetic body 1a is installed in the clamp 1, aligned with respect to the spherical permanent magnet 2.

The above conventional self-compensating dynamic balancer is disadvantageous in that the inner surface of the race 6a must be grinded smooth so that a plurality of moving members 5, which are inertial mass units, can rotate and glide smoothly in the annular races 6a. Also, the number of the moving members 5 that are to be inserted into the race 6a is determined to correspond to the extent to which the disc 3, which is placed on the turntable 6 of the spindle device, is unbalanced. Further, the moving members 5 must be precisely manufactured, and a mechanical machining error between the moving members 5 is restricted to a limited range. Therefore, a conventional self-compensating dynamic balancer is difficult to design and process, and production yield is low.

### SUMMARY OF THE INVENTION

Accordingly, it is an object of the present invention to provide a spindle device of a disc player capable of compensating for the unbalance of a disc and effectively reducing internal vibration of the disc player.

It is another object of the present invention to provide a spindle device of a display player that is simple and easy to design and manufacture, and can be mass-produced.

Additional objects and advantages of the invention will be set forth in part in the description which follows and, in part, will be obvious from the description, or may be learned by practice of the invention.

The foregoing and other objects of the present invention are achieved by providing a spindle device having a turntable on which a disc is to be placed, and a spindle motor that rotates the turntable, comprising: a self-compensating dynamic balancer having an annular race in which a moving body moves, the annular race encircling the rotational center of the turntable and having a predetermined depth and width; and an annular moving body placed in the race, the annular moving body having an inner diameter wider than the inner diameter of the race and an outer diameter narrower than the outer diameter of the race, so that the eccentric center of gravity thereof can be moved in the race.

In an aspect of the present invention, the race of the balancer is united with the peripheral portion of the turntable. The balancer may have a separate structure apart from the turntable, in which the moving body is placed in the separate structure, or be attached to the bottom of the turntable.

In another aspect of the present invention, oil is filled in the race to be in contact with the moving body, and the top of the race is sealed by a lid.

### BRIEF DESCRIPTION OF THE DRAWINGS

These and other objects and advantages of the invention will become apparent and more readily appreciated from the following description of the embodiments, taken in conjunction with the accompanying drawings of which:

FIG. 1 is a sectional view of an example of a conventional spindle device of a disc player;

FIG. 2 is an exploded perspective view of the turntable of the spindle device of FIG. 1;

FIG. 3 is a cross-sectional view of a spindle device according to an embodiment of the present invention;

FIGS. 4A and 4B are a plan view and an exploded perspective view, respectively, of a turntable of the spindle device of FIG. 3;

FIG. 5 is a plan view of a disc that is placed on the turntable in the spindle device of FIG. 3 and is in an initially spinning state;

FIG. 6 is a view of the turntable of the spindle device of FIG. 3, which balances due to self-compensation after rotating by a certain extent;

FIG. 7 is a cross-sectional view of the spindle device of FIG. 6 in which the eccentricity of a rotating body is balanced;

FIG. 8 is a view of an example a self-compensating dynamic balancer according to an embodiment of the present invention;

FIG. 9 is a cross-sectional view of a spindle device according to another embodiment of the present invention, to which the self-compensating dynamic balancer of FIG. 8 is applied; and

FIGS. 10A and 10B are views of annular moving bodies applied to a balancer in a spindle device according to the embodiments of the present invention.

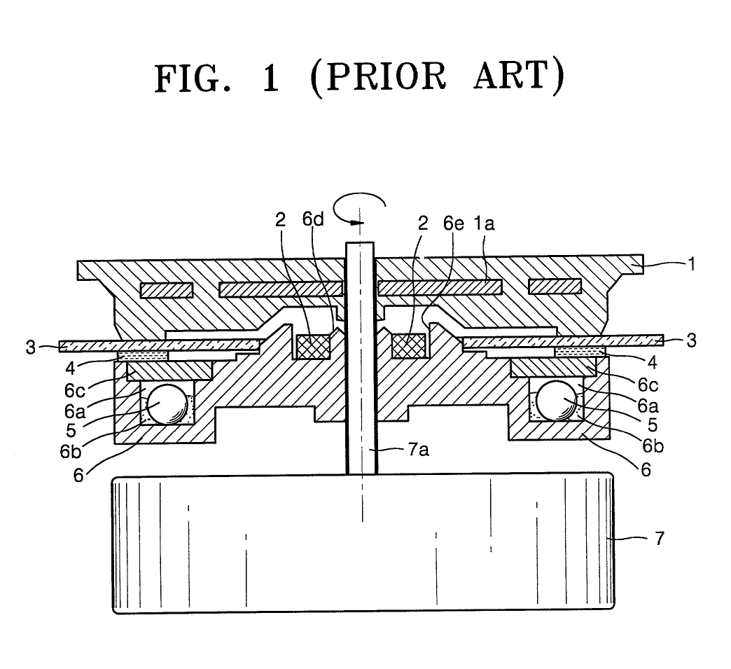

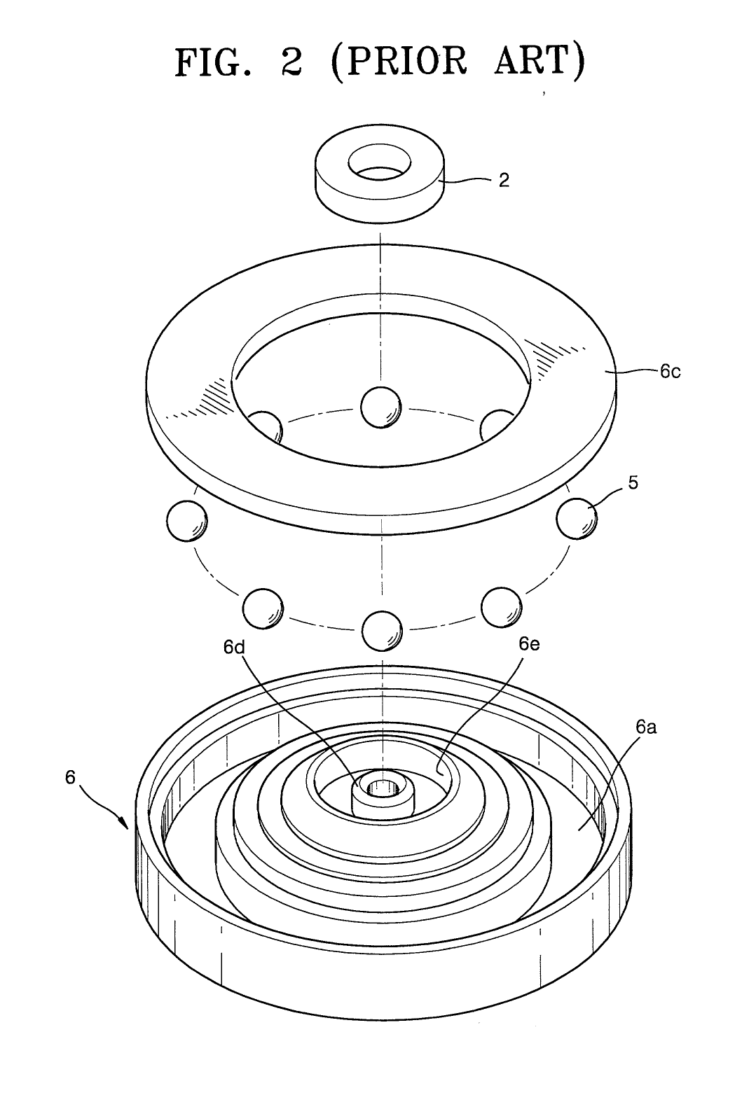

### DETAILED DESCRIPTION OF THE INVENTION

Reference will now be made in detail to the embodiments of the present invention, examples of which are illustrated in the accompanying drawings, wherein like reference numerals refer to like elements throughout. The embodiments are described below in order to explain the present invention by referring to the figures.

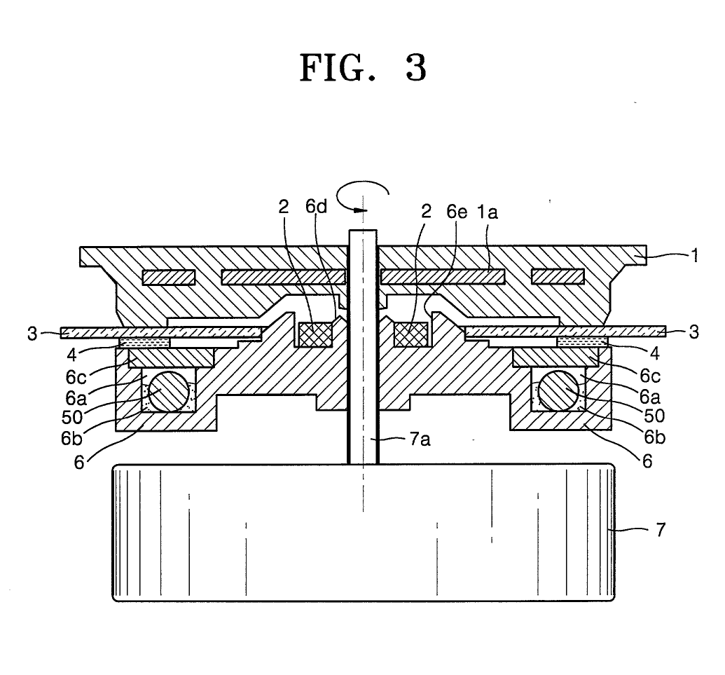

In a spindle device of a disc player as illustrated in FIG. 3, a spindle motor 7, which provides a rotational force to rotate a disc 3, has a rotational shaft 7a that is vertically arranged. The rotational shaft 7a is inserted and fixed into a central cylindrical unit 6d of a turntable 6. A spherical concave 6e having a predetermined depth and width is provided around a cylindrical unit 6d. A donut-shaped permanent magnet 2 is inserted into the spherical concave 6e.

A race 6a, which is one element of a self-compensating balancer according to the present invention, is formed at the peripheral portion of the turntable 6. The race 6a is ring or annular shaped to encircle the rotational shaft 7a in the race 6a and filled with a predetermined amount of oil 6b.

An annular moving body 50, which is to be described later, is placed in the race 6a. The size of the annular moving body 50 is determined such that it can have an eccentric orbit within a predetermined distance in the race 6a. That is, preferably, the inside diameter of the annular moving body 50 is wider than the inside diameter of the race 6a, and its outside diameter is narrower than the outside diameter of the race 6a. Also, the size of the cross-section of the annular moving body 50 is smaller than that of the race 6a. Therefore, the annular moving body 50 can revolve and move in an eccentric orbit in the race 6a. A spherical lid 6c is installed at the top of the race 6a to cover the race 6a.

A clamp 1 to fix the disc 3 on the turntable 6 is positioned at the top of the turntable 6. In the clamp 1, a magnetic body 1a is installed to correspond to the permanent magnet 2 in the spherical concave 6e.

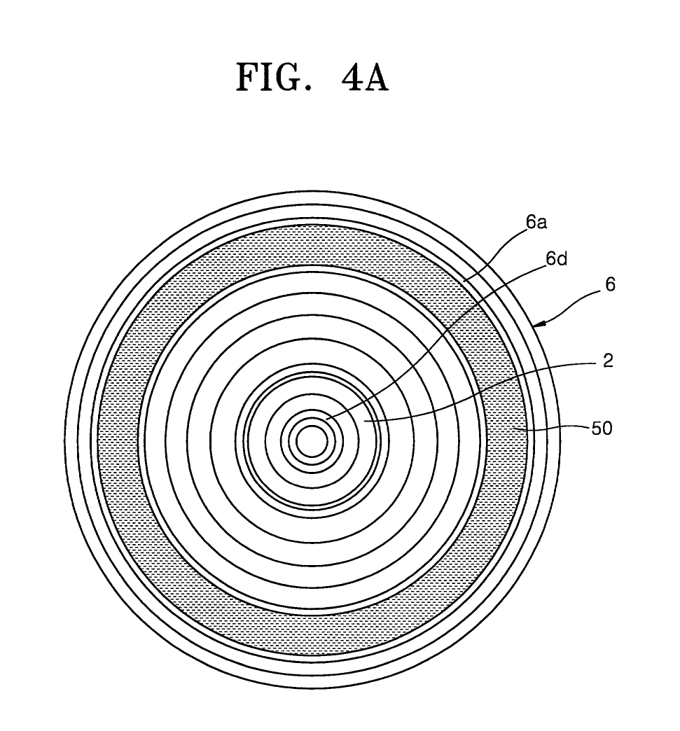

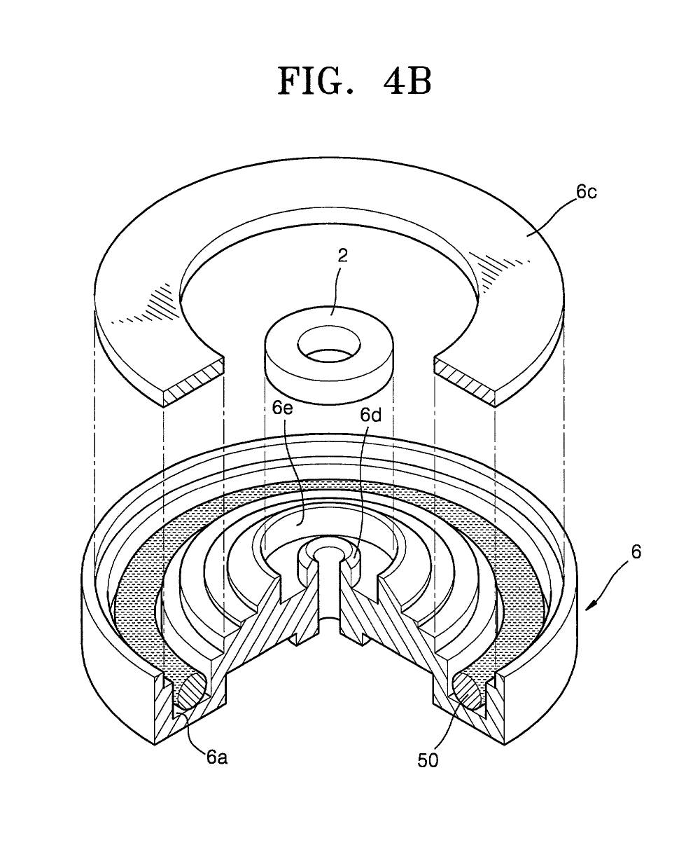

Referring to FIGS. 4A and 4B, the annular moving body 50 is placed in the race 6a on the turntable 6.

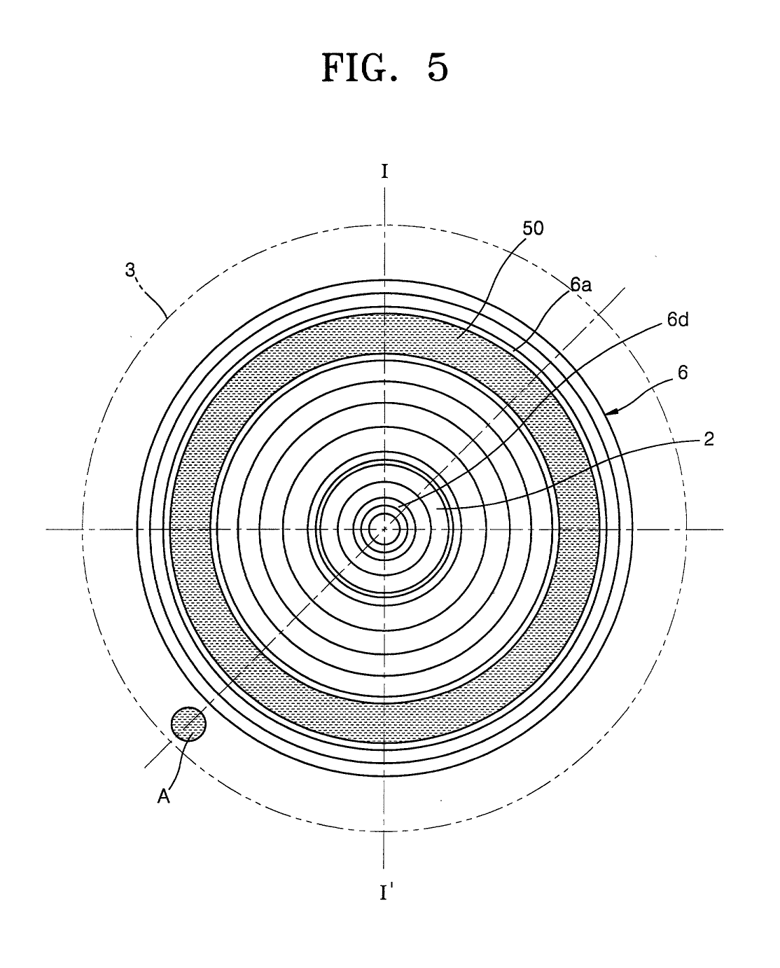

FIG. 5 is a view of an unbalanced disc 3 that is placed on the turntable 6, and is initially spinning. At this time, the annular moving body 50 has not yet settled down at a stable position in the race 6a on the turntable 6. Here, “A” denotes the eccentric mass direction and position of the disc 3 that is unbalanced.

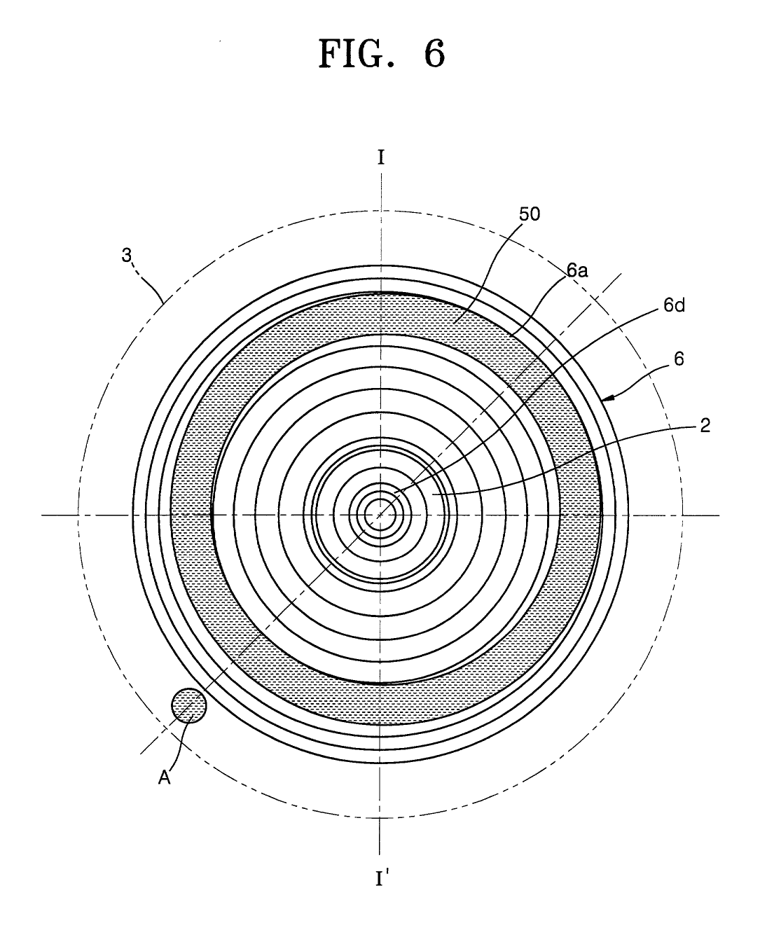

As can be seen from FIG. 6, after the turntable 6 rotates a certain extent, the annular moving body 50 is self-balanced due to a phase difference, i.e., 180°, between a spindle device and the disc 3, and moves in an eccentric orbit so as to compensate for the eccentric center of gravity of the disc. Referring to FIG. 6, if the turntable 6 is rotated for a predetermined period of time, the eccentric center of gravity shifts by 180° opposite to the angle where the disc 3 is unbalanced.

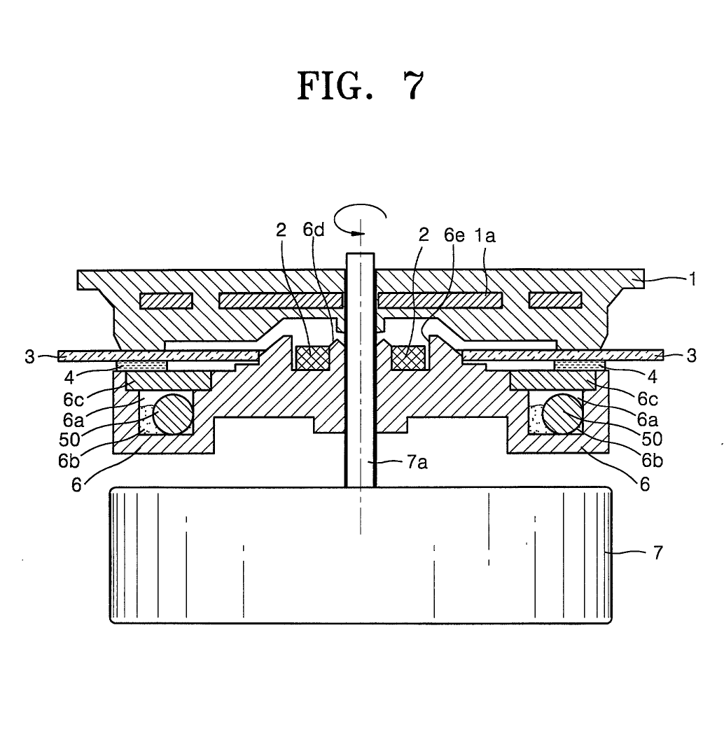

FIG. 7 is a cross-sectional view of the spindle device of FIG. 6, taken along the line I-I′.

The self-balancing capability of the above balancer, which compensates for the eccentric mass of the disc 3, is generated by the revolution or rotation of the disc 3, the number of inherent vibrations of the turntable 6, or the like, as in conventional balancers. For a better understanding of the basic principles of the self-balancing capability, please refer to the description mentioned in the related art.

In FIGS. 3 and 7, the cross-section of the annular moving body is round, but the shape of the cross-section can be modified within a range where movement of the moving body is not hindered.

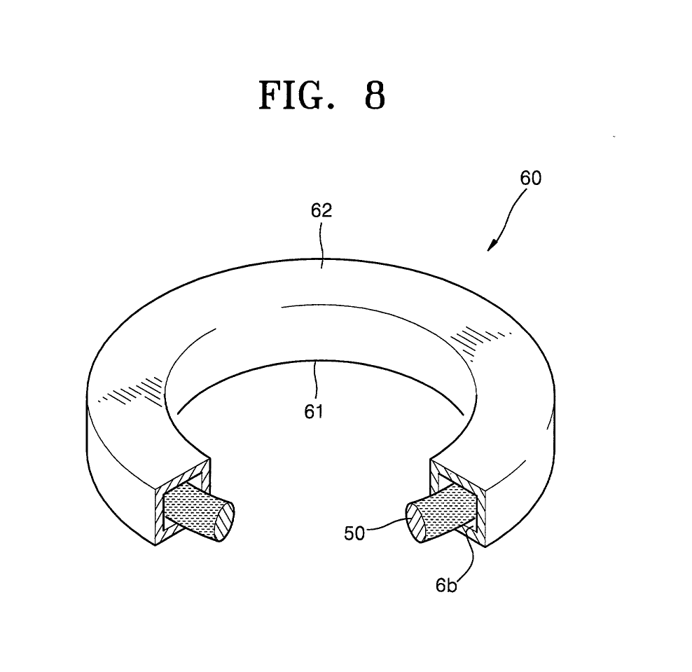

Until now, a self-compensating dynamic balancer according to an embodiment of the present invention has been described to be united with the turntable 6, but in an alternative embodiment, the self-compensating dynamic balancer can be formed to be separated from the turntable 6 (refer to a self-compensating dynamic balancer 60 in FIG. 8). The self-compensating dynamic balancer 60 of FIG. 8 includes a ring-type lower member 61 that constitutes the bottom and sidewalls of the self-compensating dynamic balancer 60 and is C-shaped; an upper member 62 fixed to cover the upper portion of the lower member 61; oil 6b filled in the lower member 61; and an annular moving body 50 placed in the lower member 61.

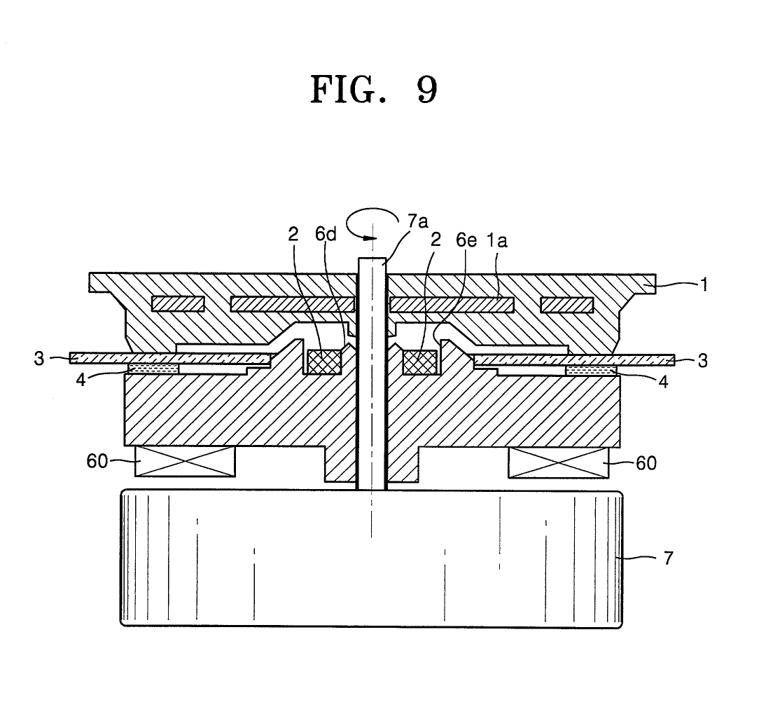

FIG. 9 is a view of another embodiment of a spindle device having a self-compensating dynamic balancer 60 as illustrated in FIG. 8, according to the present invention. Referring to FIG. 9, the self-compensating dynamic balancer 60 is attached to the bottom of the turntable 6, unlike the previously mentioned embodiments of the self-compensating dynamic balancer according to the present invention. Therefore, the turntable 6 is easy to manufacture because the self-compensating dynamic balancer 60 is made separately from the turntable 6. Further, the production yield of a spindle motor 7 can be increased.

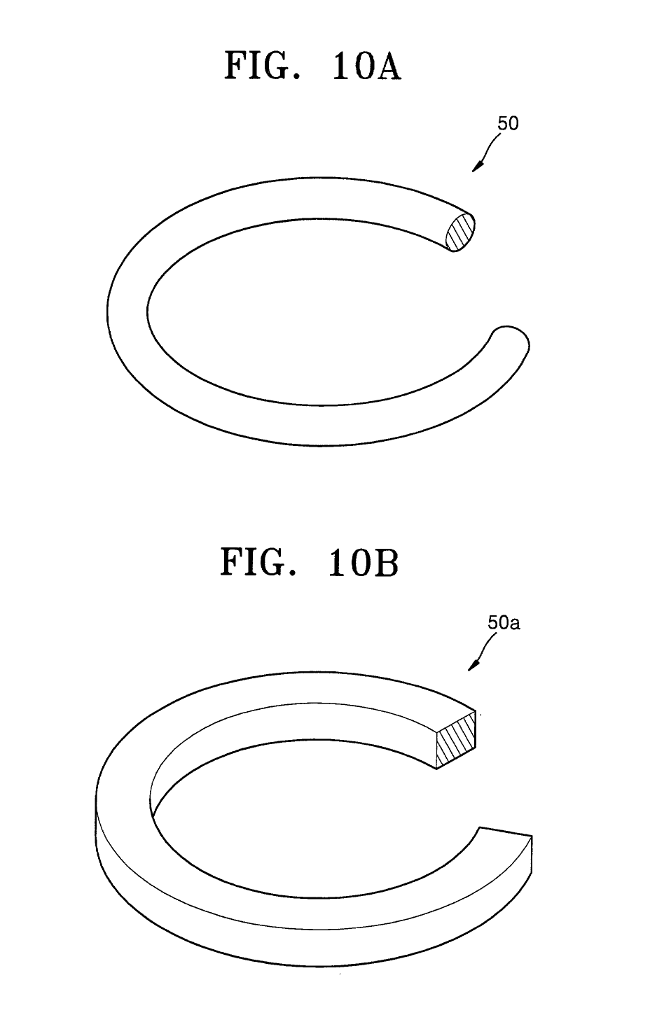

FIGS. 10A and 10B are perspective views of annular moving bodies applied to the self-compensating dynamic balancer 60 of FIG. 8. In detail, FIG. 10A is a view of an annular moving body 50 having a round cross-section, and FIG. 10B is a view of an annular moving body 50b having a rectangular cross-section.

As described above, in a spindle device according to the present invention, a race does not need to be precisely processed to have a smooth surface so as to install a ball-type moving body at a turntable. Further, a moving body is installed in a race, thereby reducing the number of components that are required in a balancer, unlike conventional spindle devices that require a plurality of moving bodies. Accordingly, a spindle device is easy to manufacture and can be mass-produced. Also, a reduction in the required components results in easy management thereof, and reduction in manufacturing costs.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A spindle device that includes a turntable on which a disc is to be placed, and a spindle motor to rotate the turntable, comprising:
a self-compensating dynamic balancer having an annular race encircling the rotational center of the turntable and having a predetermined depth and width; and
an annular moving body placed in the race to move therein, the annular moving body having an inner diameter wider than] the inner diameter of the race and an outer diameter narrower than the outer diameter of the race, so that the eccentric center of gravity thereof is movable in the race.

2. The spindle device according to claim 1, wherein the race of the self-compensating dynamic balancer is united with a peripheral portion of the turntable.

3. The spindle device according to claim 1, wherein the self-compensating dynamic balancer has a separate structure apart from the turntable.

4. The spindle device according to claim 3, wherein the self-compensating dynamic balancer is attached to the bottom of the turntable.

5. The spindle device of any one according to claim 1, wherein oil is filled in the race to be in contact with the moving body.

6. The spindle device of any one according to claim 2, wherein oil is filled in the race to be in contact with the moving body.

7. The spindle device of any one according to claim 3, wherein oil is filled in the race to be in contact with the moving body.

8. The spindle device of any one according to claim 4, wherein oil is filled in the race to be in contact with the moving body.

9. The spindle device according to claim 2, wherein the moving body has an annular cross-sect ion.

10. The spindle device according to claim 2, wherein the moving body has a rectangular cross-section.

11. The spindle device according to claim 1, wherein the size of the annular moving body is determined to have an eccentric orbit within a predetermined distance in the race.

12. The spindle device according to claim 3, wherein the self-compensating dynamic balancer comprises:
a ring-type lower member including bottom and side walls and is C-shaped; and
an upper member fixed to cover an upper portion of the lower member;
wherein the annular moving body is placed in the lower member.

13. The spindle device according to claim 1, wherein the race has a rectangular cross section.

14. The spindle device according to claim 1, wherein the race has a C-shape.

15. The spindle device according to claim 1, wherein the moving body is deformable.
